(19) United States
(12) Patent Application Publication
(10) Pub. No.: US 2021/0232494 A1
(43) Pub. Date: Jul. 29, 2021

(54) NETWORK APPLICATION TESTING USING DOMAIN-SPECIFIC NATURAL LANGUAGE

(71) Applicant: Rebaca Technologies Pvt. Ltd., Santa Clara, CA (US)

(72) Inventors: Samir K. Chatterjee, New Providence, NJ (US); Kuntal Bhattacharya, Kolkata (IN)

(21) Appl. No.: 17/102,911

(22) Filed: Nov. 24, 2020

Related U.S. Application Data
(60) Provisional application No. 62/965,430, filed on Jan. 24, 2020.
(60) Provisional application No. 62/990,530, filed on Mar. 17, 2020.

(51) Int. Cl. G06F 11/36; H04L 12/26

(52) U.S. Cl. CPC G06F 11/3688; H04L 43/045; G06F 11/3692; G06F 11/3684

(57) ABSTRACT

A method for testing interaction between processors on a network provides a test automation framework that defines a schema comprising a set of keywords and a corresponding grammar for generating one or more test scripts, wherein each test script identifies a behavior related to a network address. At least one feature file is executed, having one or more test scripts with instructions that are generated according to the defined schema. For each executed test script, a test output report lists results related to network handling of the executed test script by the corresponding network address. The method displays the generated test output report.

### CROSS REFERENCE TO RELATED APPLICATIONS

This application claims the benefit of U.S. Provisional Application Ser. No. 62/965,430 entitled “NETWORK APPLICATION TESTING USING DOMAIN-SPECIFIC NATURAL LANGUAGE” in the names of Samir K. Chaterjee et al., filed 24 Jan. 2020 and also to U.S. Provisional Application Ser. No. 62/990,530 entitled “STATE MACHINE EMULATION USING DOMAIN-SPECIFIC LANGUAGE CONSTRUCTS” in the names of Samir K. Chatterjee et al., filed 17 Mar. 2020, and is further related to the pending U.S. utility patent application Ser. No. 17/021,632 filed 15 Sep. 2020, all incorporated herein in their entirety.

### FIELD OF THE INVENTION

The present disclosure relates to methods and utilities for network applications testing and more particularly to methods for automating tests related to interoperability of network applications.

### BACKGROUND OF THE INVENTION

Interoperability of network applications allows a user to interact with a cloud or server application seamlessly, without requiring special installation setup or procedures that are tailored to the specifics of a particular network. Testing and validating interoperability can be a demanding task, particularly as advances in networking technologies make it necessary to continually upgrade both hardware and software and as improvements in networking speed and capabilities accelerate. The advent of 5G network capability has made it clear that the problem of automated testing must be addressed in order to smooth and speed up adaptation of enhanced networking.

Efficient and accurate transfer of information between applications are particular areas of concern. Thorough testing is required to ensure that all variations of a message under all operational conditions for all information elements of the message are properly implemented by the software involved in a message exchange. This testing process becomes challenging when one needs to take into account the entire set of messages that are involved to satisfy the testing requirement of a software application. The person(s) involved in testing the application must understand all the details of all the messages as per the different standards specification and is required to update this knowledge whenever there are any modifications to the specification. In addition to the knowledge of the specification, one has to understand how to test different load conditions and collect performance data for analysis.

Using conventional methods, validation of message exchange for an application that involves multiple computers distributed across several different network technologies can be a daunting task. Testing of such software becomes extremely difficult and it requires one to understand several different protocol specifications. Further, in an environment of fast-paced innovation, new standards are continuously created to enable computers connected to one network to communicate with another computer on a completely different network, sometimes using vastly different network technology. Even more demanding is the task of validating an end-to-end message exchange involving several other computers and networks participating at interim points in the transmittal process. The level and depth of knowledge required to validate such an application requires expertise that is very rare and requires constant update.

Testing a complex application using conventional methods requires a large team of knowledgeable people who are intimately familiar with all the details of all the messages that are exchanged between all the software running on different computers involved in the application. This is extremely challenging and keeping this entire team updated with fast paced technology innovation has become difficult. End-to-end test cases, i.e. Solution-level test cases, of applications that are used for building networking solutions are impacted, primarily because the task of writing any test case involves knowledge of multiple different protocols.

It can be appreciated that, given the complexity of the network interoperability testing task, automation of the process can be highly challenging. Next comes the need for automating the entire testing process so that software releases can be validated at a fast pace. The more complex and involved a software application, the more difficult to thoroughly test it without automation. Various test automation solutions exist in the industry; some are off-the-shelf and others custom developed, using different test automation frameworks.

In complex network applications, it can be very difficult to find any commercial test automation framework that provides a complete solution. Hence, in most cases, a combination of custom development, commercial software, and open-source software is applied to the problem. This means that every networking test automation solution is unique and requires a fair amount of operational training. This poses additional challenges for testing a complex network application. Beyond knowing the message protocols between computers, one is required to have a good understanding of how to operate the test automation framework itself. Since most test automation frameworks are custom applications with custom sets of software languages and user interfaces, those involved in testing, who may not be adept in software development, often struggle to write good automation scripts, i.e. test cases.

Added to this is the challenge of verifying the environment and platform on which the application is running With the advent of virtual environment and cloud platforms, applications often do not have a well-defined hardware and software environment. They need to be developed in such a manner that they operate on any environment that meets the desired specification. This requirement poses a huge challenge in validating the application. Test personnel must understand the details of the various platforms, know how to deploy the application on that platform/environment, and be able validate it against various environment configuration to ensure that the application behaves properly. In addition to knowledge of the environment, testing personnel must also understand how to configure the application.

There are various technologies adopted by different vendors, standards bodies, and organizations, e.g. Heat templates, Helm chart, TOSCA, a product of Tricentis (Mountain View, Calif.), Ansible playbook, and at times, plain Python. Each of these tools entail a considerable learning curve, where it can take months in order to develop proficiency sufficient for validation of E2E (end-to-end) complex network deployments. Hence configuring a network application for a virtual platform that is cloud native can be quite involved, requiring a thorough understanding of the underlying platform, network layers, and the network function that needs to be validated.

It is challenging and costly to train and keep an entire team of specialists updated with fast paced technology innovations. End to end test cases, i.e. solution-level test cases, of applications that are used for building networking solutions are impacted, primarily because this involves knowledge of multiple different protocols to write any test case.

Problems of environment verification, protocol compliance, and application performance are further heightened as network standards change, such as in the transition from 4G to 5G networking.

### SUMMARY

It is an object of the present disclosure to advance the art of testing network applications. An embodiment of the present disclosure provides a test automation framework that is simple to learn, use, and remember.

These objects are given only by way of illustrative example, and such objects may be exemplary of one or more embodiments of the invention. Other desirable objectives and advantages inherently achieved may occur or become apparent to those skilled in the art. The invention is defined by the appended claims.

According to one aspect of the disclosure, there is provided a method for testing interaction between a plurality of processors on a network, the method comprising:
providing a test automation framework that defines a schema comprising a set of keywords and a corresponding grammar for generating one or more test scripts, wherein each test script identifies a behavior related to a network address;
executing at least one feature file that comprises the one or more test scripts with instructions that are generated according to the defined schema;
for each executed test script, generating a test output report that lists results related to network handling of the executed test script by the corresponding network address;
and
displaying the generated test output report.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a schematic diagram that shows structure and flow for an automation framework according to an embodiment.

FIG. 2 is a schematic diagram that shows the overall architecture of the test framework comprising the BDD Engine, Service Layer, and Protocol Layer.

FIG. 3 is a schematic diagram that shows the architecture of the Protocol Layer and its interactions with the BDD Engine and Service Layer.

FIG. 4 is a schematic diagram that shows the architecture of the Service Layer and its interactions with the BDD Engine and the Protocol Layer.

FIG. 5 is a flow diagram showing handling of network communications for an automation framework, according to an embodiment of the present disclosure.

FIG. 6A shows an exemplary test script.

FIG. 6B shows an exemplary set of attribute:value pairs.

FIGS. 7A and 7B show an exemplary listing that shows the capture of the tcp dump and illustrates the complete REST Response that comes back from the server over the internet.

FIG. 8 is a listing of steps in the process for test validation with a description of each step.

FIG. 9 shows a layered communications architecture.

### DETAILED DESCRIPTION OF THE EMBODIMENTS

The following is a detailed description of the preferred embodiments, reference being made to the drawings in which the same reference numerals identify the same elements of structure in each of the several figures.

In the drawings and text that follow, like components are designated with like reference numerals, and similar descriptions concerning components and arrangement or interaction of components already described are omitted. Where they are used, the terms “first”, “second”, and so on, do not necessarily denote any ordinal or priority relation, but are simply used to more clearly distinguish one element from another.

Glue code or binding code adapts different applications for inter-operation within the same executable framework.

A solution to the interoperability testing challenge is to provide a test automation framework that abstracts the message construct details of different network protocols and the various configurations of different platforms into a form that is simple to learn, use, and remember. The Applicant's solution proposes a schema for test design and execution and uses some well-known constructs and keywords, similar to a spoken, natural language like English, wherein the constructs and keywords are relevant to the application domain.

A testing framework is a set of guidelines used for generation and design of a schema and test cases. A framework comprises a combination with a set of one or more computer processors and practices and tools that are designed to help build an effective test regimen, executed by the set of processors. In standard practice, these guidelines can include coding standards, test-data handling methods, object repositories, processes for storing test results, or information on how to access external resources, for example.

Embodiments of the present disclosure provide the ability to customize Natural Language using application domain-specific constructs. A “construct”, as the term is used herein, relates to a defined set of grammatical rules and relationships that are valid when using the set of defined keywords. The Applicant has found that this approach provides a general-purpose Test Automation Framework that can be readily customized according to domain knowledge.

Behavior Driven Development (BDD) is one such well known approach, based on natural language constructs. BDD uses simple keywords like “Given, When, Then” to define system behavior. For example, “Given” defines the “pre-condition” of the application state and environment; “When” identifies the “test step” or the actions along with the payload (specific message detail) that needs to be carried out, sent or published; and finally, “Then” specifies the expected outcome of the action and verifies the response output along with the message detail. In some cases, “When” can specify the message request to be sent and “Then” validates the actual response against the expected response, without “Given”.

Various approaches have been used for automation frameworks in different applications. For example, some conventional automation frameworks are driven by Keywords. In a keyword-driven framework, each function of the application under test is laid out in a table with a series of instructions in consecutive order for each test that needs to be run. In such cases, the test steps within a test case are created using special keywords as defined by the automation framework. The framework provides a set of specially defined keywords in order to trigger various actions or validations and the test steps are created using them. The Applicants' approach offers the following benefits over Keyword based Automation Frameworks:
(i) Test personnel do not need to remember specific and often cryptic keywords. Instead, there are only a relatively few natural language constructs which the testers can learn and become expert on very easily in a short time span.
(ii) BDD grammars can be made polymorphic, allowing increases in scale to be more readily accomplished, without having to create new constructs for every change or, enhancement of the product.
(iii) BDD grammars can be more generalized by using parameters, so that there are less variances and limited constructs to learn for the testers.
(iv) Using natural language constructs, the Test Cases and Reports can easily be understood, integrated, and used by anyone (Test engineering, Domain expert, Customer) who understands the product or the domain without having to learn a huge set of Keywords that are implemented by the automation framework.

There are some available Automation Frameworks where the test cases are implemented using a programming or scripting language like Java, Python, Javascript, Perl, Shell etc. In that case, each test case is implemented either as a class, program file or a function in some High-Level Language programming construct. We have the following benefits of our approach over Programming/Scripting-based Automation Frameworks:
1. The testers do not need to be programmers. Only the product knowledge or the domain knowledge is expected from the testers.
2. Any change or enhancements inside the Automation Framework can be abstracted from the tester.
3. Ramping up of the testing team is much easier.
4. Because of the natural language constructs, the Test Cases and Reports can easily be consumed by anyone (Test engg, Domain expert, Customer) who understands the product or the domain without having to learn any programming language.

There are some Automation Frameworks where the test cases are implemented by dragging and dropping various GUI components. In that case the call sequences are created in the GUI by using a graphical toolkit as provided by the Automation Framework. The Applicants' approach offers a number of benefits over GUI based Automation Frameworks, including the following:
1. Since BDD based test cases are implemented in text, it is much faster and easier to implement a test case.
2. The tester can use any Integrated Development Environment (IDE) of choice for creating the test cases rather than having to use a costlier and bulkier graphical IDE.
3. The protocol layer makes our solution more flexible to interoperate with various other open source, custom or 3^{rd} party toolchains.
4. Because of the natural language constructs, the Test Cases and Reports can easily be consumed by anyone (Test engineer, Domain expert, Customer) who understands the product or the domain without having to learn any graphical toolkit.

Applying BDD to implement test automation scripts (Feature File or FF) for network call sequences enables one to understand and parse the intent of the FF and then correlate it with the messages, logs and associated KPIs of the applications (network nodes) involved. This also helps in deep packet inspection on the network communication and can help to associate the network logic with PP use cases. To the Applicants' knowledge, BDD has not been applied to the problem of testing network call sequences and interaction on a large scale. The Applicants have found that use of this solution can be particularly effective where the network interaction and protocols are in the process of significant change, while expected to provide seamless operation with existing applications between network nodes.

In conventional applications, BDD methodology is primarily used to define product features. Usage of BDD grammars with constructs and keywords to describe network messages and nodes in natural language is not an obvious approach. As mentioned earlier, the combination employed by embodiments of the present disclosure can help to simulate network components, implementing test scripts for network call sequences and validating them in a unique manner. The combination, when done in an optimal manner, also helps by providing a small subset of dictionary terms that represent an entire set of messages in an efficient hierarchical manner Since this procedure is expressed and arranged according to natural language, it is easy to learn and train. This aspect of embodiments of the present disclosure has particular value for use in transition to the mobile 5G network, for which new specifications for different applications are being continually developed.

### Constructs

BDD also defines some grammars or constructs to be used along with the keywords as part of the schema in order to form sentences, in standard, spoken language, for defining the message interactions; the defined grammars or constructs prove to be straightforward to use and understand. With the constructs appropriately tuned, by those having sufficient domain understanding to make it intuitive for a particular application, training of human and machine operators can be performed more efficiently. These constructs are specified to uniquely identify the behavior of the particular application/solution.

Constructs and test regimen designed in accordance with this schema can be extended to support new business requirements that cannot be addressed by the existing set of instructions. However, extending the construct needs to be done within the schema and its framework structure, so that extension does not increase the dictionary of constructs unnecessarily, thus making it difficult to remember. The requirement for such an extension or the design needs to take into account that the dictionary of constructs does not expand unnecessarily and does not require constant modifications whenever a specification of a message changes or an additional information element is added to a message. This is done by the framework development team only.

Using the set of simple keywords, following the defined constructs, one can define an interaction or behavior between two software modules and perform-deep packet inspection of all communications between them. By chaining such definitions, one can validate the behavioral interaction between multiple different software components running on several computers on networks distributed across the world.

According to an embodiment of the present disclosure, the proposed automation schema uses three basic keywords and a limited set of domain-specific constructs or grammars to build a natural language user interface. Ability to test a message using natural language like English or other spoken language, in a manner specific to the application domain, helps to make it straightforward to learn and use the automation framework of the present disclosure.

### Feature Files

Test scripts written using BDD are appropriately termed “feature files” since they test the product features. The “Given-When-Then” construction specifies how the product will behave, e.g. Given the context, When the action is done, Then how the product should behave. Ensuring that the domain knowledge is built into the constructs used enables anyone familiar with the domain (e.g. test engineer, domain expert and customer) to compose a test automation script with minimal ramp-up. All the user needs to know is the message and the information element of the message that needs to be validated. Using the BDD keywords and the domain-specific constructs, one can declare the pre-condition of the software state and the environment, the message that needs to be sent with the interested parameters, and the validation criteria of the expected response. The test script and feature file can be embodied as text files. A particular test script can be used to emulate user behavior at a network address.

### Business Advantages

Automation test scripts in most utilities are not naturally human readable. Instead, these are formulated as “scripts” that are used by some parsers in the tools to extract the intent of the test script/case and process accordingly. In order to use a script language effectively, one needs to be trained for reading, writing, or editing with the proper syntax, etc. This does not allow natural collaboration, without any training, between different stakeholders involved in creating and delivering the application, (e.g. Product Owner, Developers, Testers, Support team) even though they know the domain well. Even though the engineering team, meaning the developers and testers, can be trained with some effort, the business and support team struggles to use the existing solutions. This also has an effect on ability to utilize Machine Learning approaches to analyze the input and output of these tools for further analysis.

For network communication, methods of the present disclosure allow the test team to author an end-to-end test specification of a standard specified call model e.g. 3GPP (3G/4G/5G) involving several network elements using natural language-based DSL. This also allows testing of negative use cases in a standard specified call model.

### Glue Code and the BDD Engine

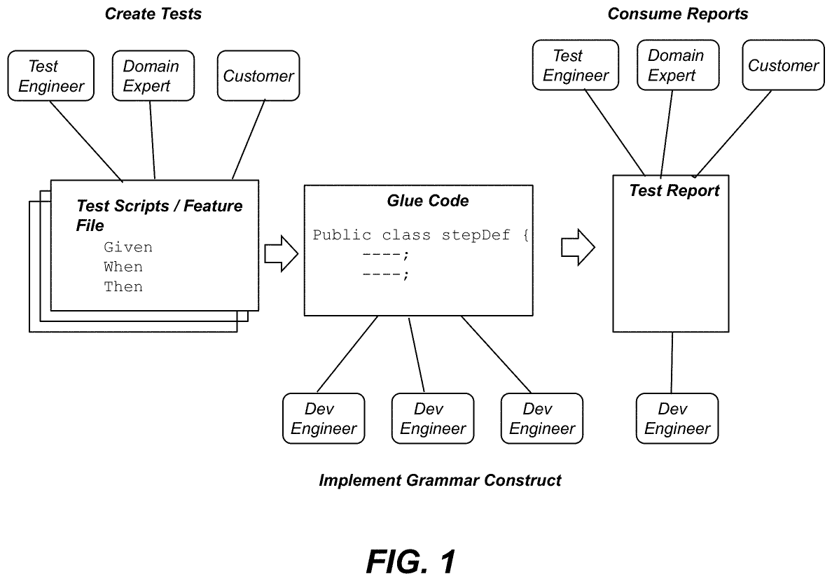

Referring to the process shown in FIG. 1, the heart of this automation framework is a BDD engine and its glue code component that parses the keywords and the constructs of the test script (feature files) that are written. The parsing routine can be developed in any software language of choice (e.g. Java, Python, Javascript, Ruby etc.). The test automation framework engineers are responsible for developing these parsers. The person writing the feature file need not worry about language syntax, grammar, and other details and need only remember the constructs, which describes the message exchange behavior of the application. Glue code adapts different applications for inter-operation within the same executable framework.

Following this schema, each statement of the test script/feature file is parsed by the automation frame work into three different parts:
(i) the keyword used in the message (given, when or then);
(ii) the application domain specific constructs; and
(iii) the message declared in the script.

The automation framework parses the BDD grammar and constructs in order to understand the intent of the test script, then uses the parameters provided in the constructs in order to perform the test step.

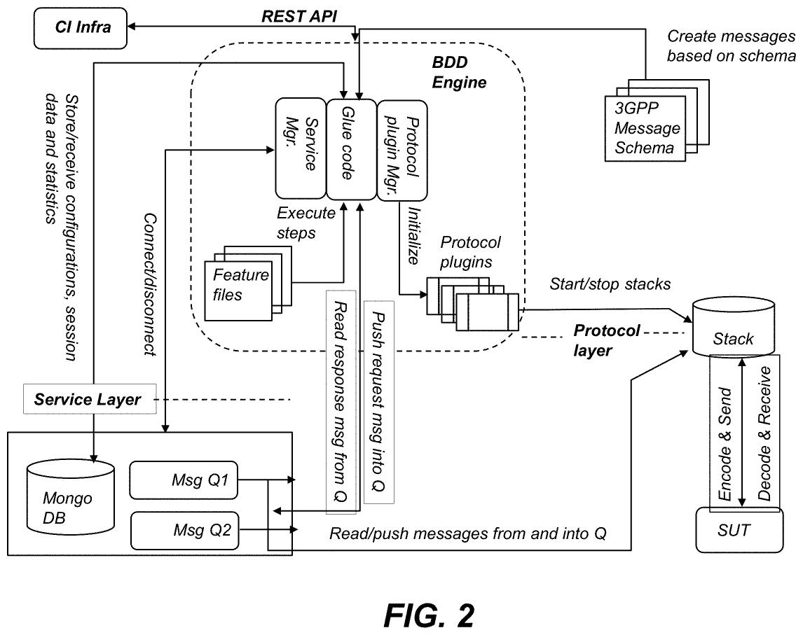

The architecture diagram shown in FIG. 2, illustrates the internals of the BDD Engine component of the test automation framework, executing on the one or more processors within the automation framework, that has been developed around the Glue Code. The BDD Engine reads the 3GPP/IEEE Message Schemas from the file system, and creates messages to be used in any 3GPP/IEEE procedures based on the schemas. During test execution, once the BDD test cases are parsed by the Glue Code, the BDD Engine is configured to determine what procedure is to be executed, with the defined set of messages within that procedure along with its payload.

After generating the Procedures and the messages within the procedures, the BDD Engine uses the different Protocol Plugins to signal the Protocol Layer to start the required Protocol Stacks.

The BDD Engine uses the Service Manager in order to communicate with the Service Layer. The Service Layer is used for the following purposes:
(i) Store records pertaining to the user agent, attributes, sessions, counters etc., such as in a distributed database, such as a Mongo database.
(ii) Host Message Queues (Msg Q1, Q2) for interacting with the different Protocol Stacks within the protocol layer. The BDD Engine places Procedures, Messages and their Payloads in the corresponding message queue of the Service Layer for further processing.

### Use of the Protocol Layer

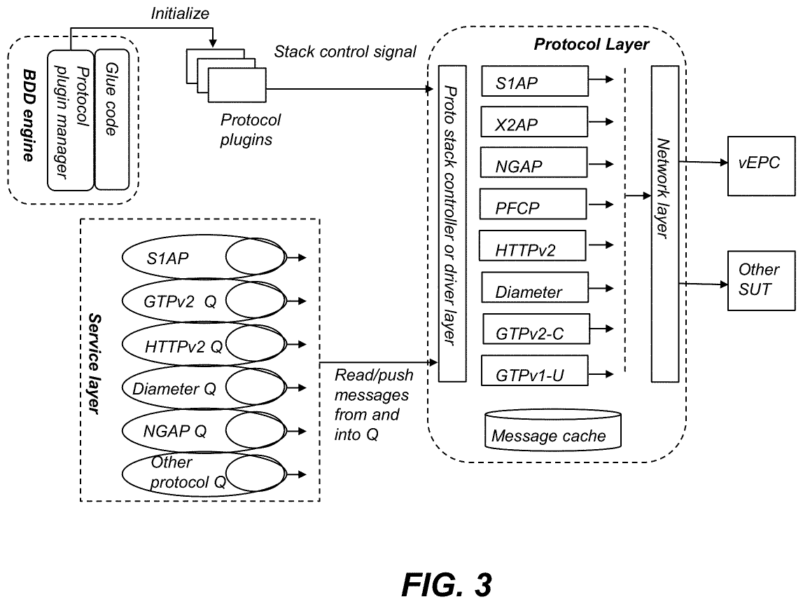

FIG. 3 is a schematic diagram that shows the architecture of the Protocol Layer and its interactions with the BDD Engine and Service Layer. The architecture diagram shown in FIG. 3, illustrates the internals of the Protocol Layer component of the automation framework. The main purpose of the Protocol Layer is to host different Telecom protocol stacks and use them to send and receive messages over the network. Telecom protocols that can be supported include Diameter, S1AP (S1 Application Protocol), X2AP (X2 Application Protocol), NGAP (NG Application Protocol), PFCF (Packet Forwarding Control Protocol), HTTP and HTTPv2 (Hypertext Transfer Protocol), GTPv2 (GPRS Tunneling Protocol), SIP (Session Initiation Protocol), SSH File Transfer Protocol, SMPP (Short Message Peer-to-Peer), SMTP, SNMP (Simple Network Management Protocol), COAP, MQTT (MQ Telemetry Transport), and others.

The Protocol Layer has the Protocol Stack Controller which receives instructions, commands, and messages from the BDD Engine and the Service Layer and drives the protocol stacks accordingly. The Protocol Stack Controller is hence called as the Driver Layer of the test automation framework.

The Driver Layer (Protocol Stack Controller) receives the initial signal from the BDD Engine as to which protocol stacks to be configured. It creates the corresponding protocol stacks and manages them during the lifecycle of the automation framework. The protocol stacks are responsible to Encode and Send messages to the network as well as Receive and Decode messages from the network.

Once the BDD test cases start executing, the Driver Layer receives each messages along with its payload that is to be sent to the endpoint from the Service Layer. The Driver Layer uses the corresponding protocol stack to encode and send the message to the identified endpoint. On receipt of any response from any endpoint, the Driver Layer also fetches the decoded response message along with its payload and sends back to the Service Layer for further processing.

### Use of the Service Layer

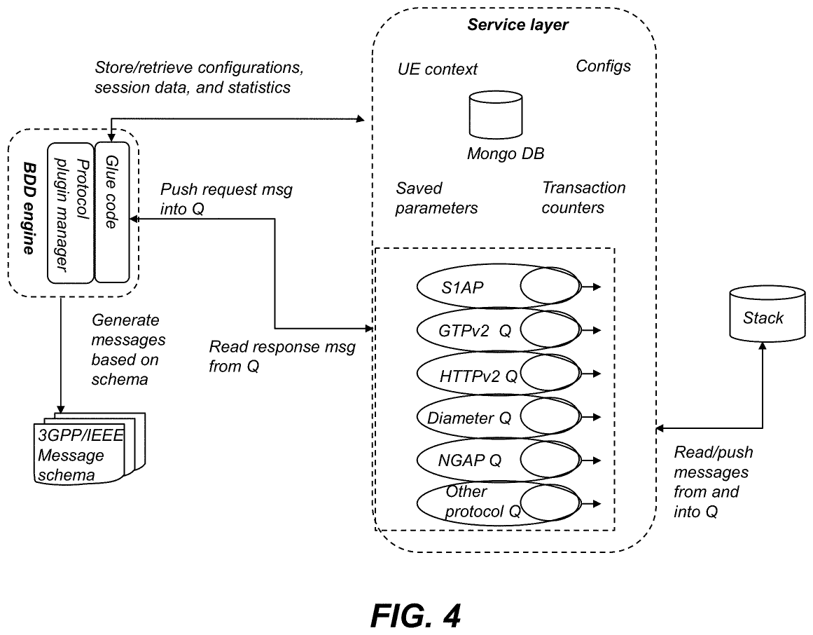

FIG. 4 is a schematic diagram that shows the architecture of the Service Layer and its interactions with the BDD Engine and the Protocol Layer. The architecture diagram in FIG. 4, illustrates internals of the Service Layer component of the automation framework. The Service Layer has two fundamental components, Storage and Queues. The Storage component of the Service Layer comprises of a distributed database, such as a MongoDB, which is a high performance, no-SQL database engine. The storage component is primarily used and managed by the BDD Engine in order to store and retrieve various records pertaining to users, sessions, attributes, messages, counters etc. These values are sometimes used in the series of messages within a call flow or, a procedure as mentioned by the BDD test cases. The storage component is also used when a test case wants to save some configurations or parameters for any future steps.

The Service Layer has another component which implements the Message Queues for each protocol. Each queue in the service layer serves one protocol and keeps all commands, messages and their payloads in the incoming order in the queue. The BDD Engine pushes the next message to the corresponding queue in the service layer. The Driver Layer, or the Protocol Stack Controller is notified accordingly, at it reads from the service layer queue and drives the corresponding protocol stack for further processing. Once the response is available from the network endpoint, the Driver Layer puts the response message in the queue and the BDD Engine is notified accordingly. The BDD Engine then reads from the queue and process the test step.

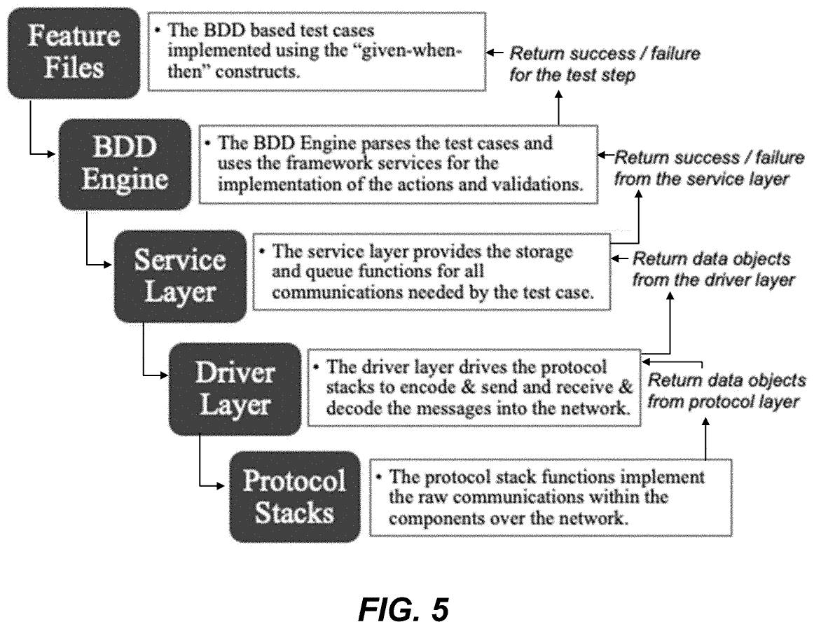

FIG. 5 is a flow diagram showing handling of network communications for an automation framework, according to an embodiment of the present disclosure. BDD test cases, implemented using the base set of constructs and stored as feature files, are passed to BDD Engine processing, which parses the test cases and directs activities and validation of the automation framework services. The Service Layer provides the storage and the queue functions used for services of the automation framework, returning success or failure indicators. The Driver Layer drives the protocol stacks in order to perform encoding, decoding, sending and receiving messages functionalities to the service layer as received. A collection of Protocol Stacks handles the raw communications over the network, returning data objects received in network communication.

The code block shown in FIGS. 4A and 4B elaborates on how the When construct is implemented in the glue code. The glue code function generates the corresponding HttpMethod (get, post, put, delete or patch) as provided in the test step. It then calls the sendRequest method of the RestService and passes on the resource URI, endpoint (identified by the server instance) and the http method as provided in the test step. The function asserts failure with appropriate error message and error code in case the REST API request is unsuccessful and captures all details in the final report.

The sendRequest method in the service layer receives the resource URI, endpoint and http method from the glue code, and if the provided http method is valid, then creates the HttpMessage from the provided resource URI and http method. The function then invokes the sendRequest method of the RestDriver and passes on the endpoint and the newly created HttpMessage and returns the result to the caller as received from the RestDriver.

FIG. 4C is a flow diagram showing handling of network communications for an automation framework, according to an embodiment of the present disclosure. BDD test cases, implemented using the base set of constructs and stored as feature files, are passed to glue layer processing, which parses the test cases and directs activities and validation of the automation framework services. The service layer provides the processing logic that is used for services of the automation framework, returning success or failure indicators. The driver layer includes functions that provide implementation to obtain the needed data objects, providing these to the service layer as received. A protocol layer handles the raw communications over the network, returning data objects received in network communication.

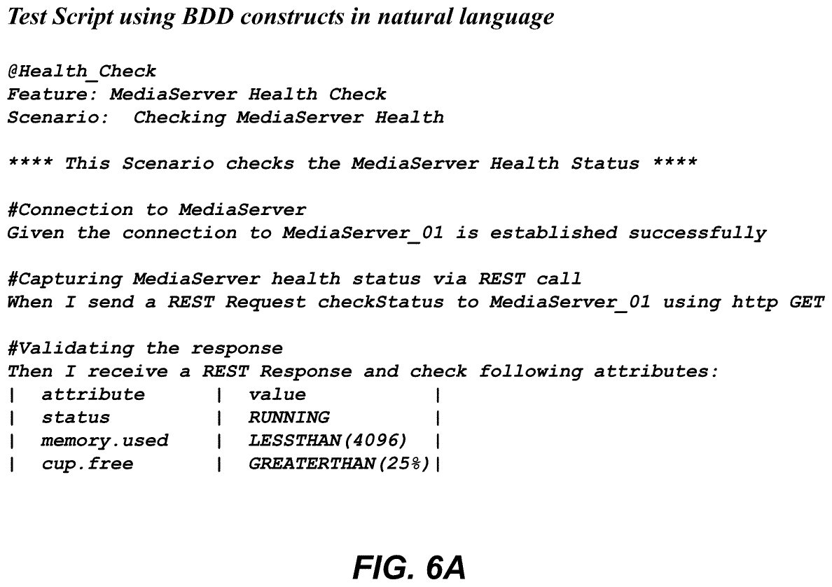

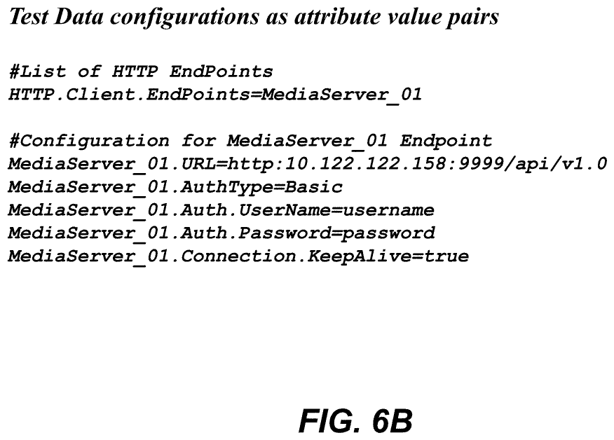

As shown in FIGS. 6A, 6B, the automation framework encapsulates all the above implementations and only provides the parameterized BDD constructs to the external world in the natural language. In the example shown, one typical use of the set of instructions as Given, When, and Then conditions is illustrated. The test automation framework defines one or more given conditions with the Given keyword, then defines an event with the When keyword, followed by a response outcome, phrased using the Then keyword.

Using the test schema as shown in the simple example of FIG. 6A, a test engineer can generate a simple test script (using natural language constructs) and test data configurations (in an attribute-value pair) as shown in the FIG. 6A, 6B example, without involvement in details about how a REST API based HTTP message can be created, sent and validated over the TCP/IP connection.

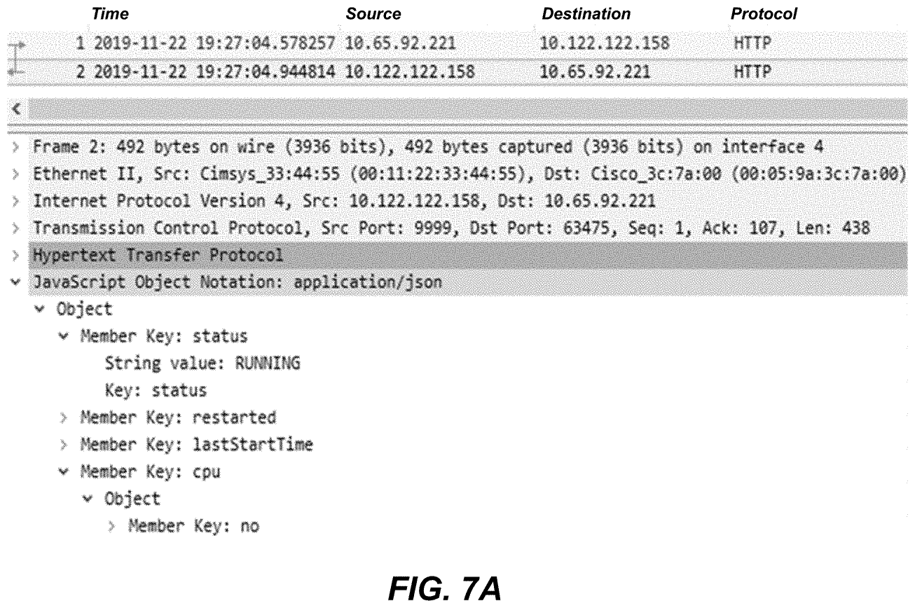

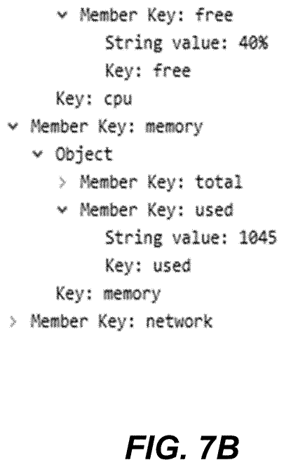

On execution of the FIG. 6A test script, the automation framework executes the entire call flow and also captures reports and other associated artefacts. The testing can execute a repeated loop, storing cumulative results of the executed test scripts. One useful artefact is the capture of all the network packets that are exchanged in the wire. This allows display of the network packet transactions corresponding to the test sequence. For example, the capture of the tcp (Transmission Control Protocol) dump in FIGS. 7A, 7B illustrates the complete REST Response that returns from the server over the internet. The test personnel can see the message payload in server response in the wire, and can go back and compare validation in the Feature File using the simple BDD constructs.

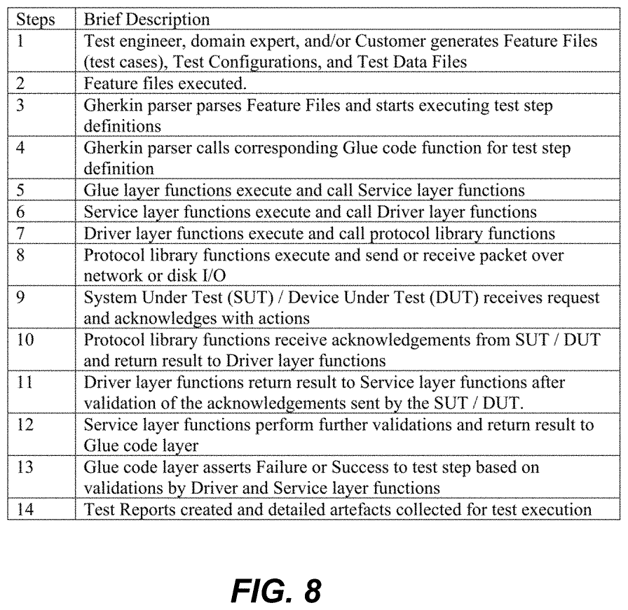

FIG. 8 lists steps in the process and provides a description of each step. This processing is performed in conjunction with protocol libraries for testing network solutions.

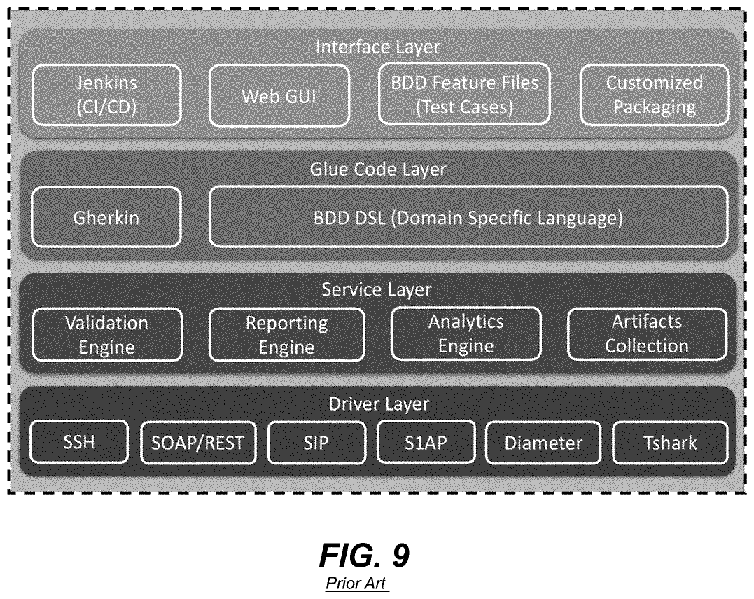

FIG. 9 shows an arrangement of interface layers according to a typical embodiment for network application testing. This diagram shows the relative position of the glue code functions for network testing, according to an embodiment of the present disclosure.

The Applicants' implementation approach provides the flexibility and the configurability of the layered architecture of FIG. 9. This allows swapping of protocol drivers based on need, switching interfaces as necessary, extending support to any toolchain (open source or custom), the ability to integrate with any CI-CD pipeline, and also to interface with a range of external Servers or Engines as necessary. These capabilities are all adapted for accessibility using BDD. Users can perform this range of functions (even interfacing with external tools, servers, engines) using natural language-based BDD grammars

According to an embodiment of the present disclosure, a method for testing network interaction provides an automation framework that is configured to execute a set of Behavior-Driven Development (BDD) constructs that define product features and accepts a test script that includes the set of BDD constructs. The method generates a test output report that lists test script results for display, such as on a display monitor that is in signal communication with a processor. The BDD constructs can be generated in human-readable text form. The automation framework can use a layered structure. A method for testing network interaction provides an automation framework, generates a set of BDD constructs that define product features, accepts a test script that uses the set of BDD constructs, and generates an output report that lists test script results. It can be appreciated that having input and output data that is understandable and readily possible simplifies tasks of generating statistical data and analyzing test execution data.

The invention has been described in detail with particular reference to certain preferred embodiments thereof, but it will be understood that variations and modifications can be effected within the spirit and scope of the invention

1. A method for testing interaction between a plurality of processors on a network, the method comprising:
providing a test automation framework that defines a schema comprising a set of keywords and a corresponding grammar for generating one or more test scripts, wherein each test script identifies a behavior related to a network address;
executing at least one feature file that comprises the one or more test scripts with instructions that are generated according to the defined schema;
for each executed test script, generating a test output report that lists results related to network handling of the executed test script by the corresponding network address;
and
displaying the generated test output report.

2. The method of claim 1 wherein providing the test automation framework comprises defining one or more given conditions, events, and response outcomes.

3. The method of claim 1 wherein the identified behavior comprises sending a response message between two network addresses.

4. The method of claim 1 wherein the generated test output report indicates success or failure.

5. The method of claim 1 further comprising automatically repeating the feature file execution and storing cumulative results in the generated test output report.

6. The method of claim 1 further comprising capturing one or more network packets.

7. The method of claim 1 further comprising displaying one or more captured network packets.

8. The method of claim 1 wherein the feature file is expressed in a spoken language and generated in a human-readable form.

9. The method of claim 1 wherein executing the feature file comprises executing service layer and driver layer functions for a networked processor.

10. The method of claim 1 wherein the network address corresponds to a processor.

11. The method of claim 1 wherein the feature file is stored as a text file.

12. The method of claim 1 wherein executing the at least one feature file further comprises invoking a protocol layer and service layer routine.

13. A method for testing interaction between a plurality of processors on a network, the method comprising:
providing a test automation framework that defines a schema comprising a set of keywords and a corresponding grammar for generating one or more test scripts, wherein each test script identifies at least one condition, at least one event, and at least one response behavior related to a network address;
executing at least one feature file that comprises the one or more test scripts that are generated according to the defined schema and set of instructions;
for each executed test script, storing results in a distributed database and generating a test output report that lists results related to network handling of the executed test script by the corresponding network address;
and
displaying, storing, or transmitting the generated test output report.

14. The method of claim 13 wherein storing results comprises capturing one or more network packets.

15. The method of claim 13 wherein the test interaction tests a telecommunications call model.

16. The method of claim 13 further comprising emulating a user behavior at a network address.

17. The method of claim 13 wherein the network address corresponds to a processor.

18. The method of claim 13 wherein the feature file is stored as a text file.

19. The method of claim 13 wherein executing the at least one feature file further comprises invoking a protocol layer and service layer routine.
